(19) United States
(12) Patent Application Publication
(10) Pub. No.: US 2003/0000152 A1
(43) Pub. Date: Jan. 2, 2003

(54) Apparatus for protecting a structural column

(76) Inventor: James P. Ryan, Lakewood, OH (US)

Correspondence Address: John M. Skeriotis, Emerson & Skeriotis, 14th Floor, One Cascade Plaza, Akron, OH, 44308-1381, US

(21) Appl. No.: 10/188,021

(22) Filed: Jul. 1, 2002

Related U.S. Application Data
(60) Provisional application No. 60/302,105, filed on Jun. 29, 2001.

(51) Int. Cl. E04B 1/34; B32B 3/00; F16F 5/00; F16F 9/00; B61G 11/12; E02D 5/60; E02D 31/00; E04C 3/30

(52) U.S. Cl. 52/3; 52/736.4; 267/116; 405/216; 428/71

(57) ABSTRACT

An apparatus for protecting a structural column from an impact includes a flexible pad configured to have an installed position wrapped about the column. The original width of the pad is defined by and between opposite side edges. The height of the pad is defined by and between upper and lower end edges that extend horizontally about the column when the pad is in the installed position. An outer side surface of the pad is non-corrugated, and in innerside surface is corrugated. The corrugated inner side surface has ribs that are configured to extend vertically in contact with the column when the pad is in the installed position. Grooves that separate the ribs are configured as cutting guides along which the pad can be severed to adopt a reduced width corresponding to particular column.

This utility patent application claims priority from a provisional patent application having serial No. 60/302,105 filed on Jun. 29, 2001.

### BACKGROUND OF THE INVENTION

A. Field of Invention

The present invention relates to an apparatus and method for protecting a structural column from impact from moving vehicles.

B. Description of the Related Art

Impacts between a moving vehicle and a structural column can damage both the vehicle and the column. Therefore, it is sometimes desirable to place an impact protection device about the column.

In U.S. Pat. No. 4,244,156 to Watts, Jr., a pole and piling protector is described. A plastic shell having a corrugated outer surface encircles a pole or piling. The ends of the shell overlap to secure the plastic shell around the pole. A foamed adhesive between the shell and pole fills and seals the inner surface of the shell to the pole.

A need exists in the art for an apparatus that protects a column that is durable, easy to use, and provides for increased column protection.

### SUMMARY OF THE INVENTION

An apparatus for protecting a structural column from an impact includes a flexible pad configured to have an installed position wrapped about the column. The original width of the pad is defined by and between opposite side edges. The height of the pad is defined by and between upper and lower end edges that extend horizontally about the column when the pad is in the installed position. An outer side surface of the pad is non-corrugated, and an inner side surface is corrugated. The corrugated inner side surface has ribs that are configured to extend vertically in contact with the column when the pad is in the installed position. Grooves that separate the ribs are configured as cutting guides along which the pad can be severed to adopt a reduced width corresponding to a particular column.

In a particular embodiment, a strap is configured to fasten the pad in the installed position either in the original width or in any reduced width achieved through the severing. A horizontally extending recess at the outer side surface can receive the strap when the pad is in the installed position. The side edges are free of a fastening structure. The pad is flexible to enable bending of the pad from a flat condition to a bent condition for wrapping about the column. The outer side surface is planar when the pad is in the flat condition. A compressible core of the pad is enveloped by a noncompressible shell. Preferably, the shell completely envelopes the core, such that the shell defines the upper and lower end edges, the inner and outer side surfaces, and the side edges when the pad has the original width. The shell is preferably bonded to the core.

Accordingly, it is an object of the present invention to provide an apparatus that is more economical to manufacture.

It is yet another object of the present invention to provide an apparatus that provides increased protection to the column it surrounds.

Still, another object of the present invention is to provide an apparatus that is easy to use.

Further, another object of the present invention to provide an apparatus for protecting a structural column from an impact, wherein the pad has a horizontally-extending recess at the outer side surface for receiving the strap when the pad is in the installed position.

It is yet another object of the present invention to provide an apparatus, wherein the side edges are free of a fastening structure.

Further, another object of the present invention is to provide an apparatus, wherein the pad is flexible to enable bending of the pad from a flat condition to a bent condition for wrapping about the column, and wherein the outer side surface is planar when the pad is in the flat condition.

Still, another object of the present invention is to provide an apparatus, wherein the pad is configured to extend only partly around the periphery of the column when the pad is in the installed position.

Another object of the present invention is to provide an apparatus, wherein the pad has a compressible core and a noncompressible shell that envelopes the core.

Yet, another object of the present invention is to provide an apparatus, wherein the shell completely envelopes the core, such that the shell defines the upper and lower end edges, the inner and outer side surfaces, and the side edges when the pad has the original width.

Still yet, another object of the present invention is to provide an apparatus, further comprising a plurality of pads adapted to wrap about the column, wherein one or more of the pads can be severed to adopt a width suitable for the pads to span the entire circumference of the column.

Further, another object of the present invention is to provide a method for installing a column protector, comprising the steps of:

providing a flexible pad configured to have an installed position wrapped about the column; the pad having an original width defined by and between opposite side edges, and having a height defined by and between upper and lower end edges that extend horizontally about the column when the pad is in the installed position; and, the pad having a non-corrugated outer side surface, and corrugated inner side surface having ribs configured to extend vertically in contact with the column when the pad is in the installed position;

bending the pad inwardly toward the corrugated inner side;

wrapping the pad around the column; and,

securing the pad to the column.

Another object of the present invention is to provide a method for installing a column protector, wherein the corrugated inner surface comprises a groove, the groove being a cutting guide.

Still yet, another object of the present invention is to provide a method for installing a column protector, further comprising the step of:

severing the pad along the groove;

reducing the width of the pad; and,

wrapping the pad around the column, wherein the column circumference is less than the original pad width.

Another object of the present invention is to provide a method for installing a column protector further comprising the step of:

providing a plurality of pads, wherein each of the pads is configured to have an installed position wrapped about the column; the pads having an original width defined by and between opposite side edges, and having a height defined by and between upper and lower end edges that extend horizontally about the column when the pads are in the installed position; and, each of the pads having a non-corrugated outer side surface, and corrugated inner side surface having ribs configured to extend vertically in contact with the column when the pad is in the installed position, the column having a circumference larger than the original width of each pad; and,

wrapping the plurality of pads about the circumference of the column.

Still yet, another object of the present invention is to provide a method for installing a column protector, further comprising the steps of:

severing at least one of the pads along a groove so that the pad width is smaller than the original width; and,

securing the pads to the column without the pads overlapping each other.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of an apparatus comprising an embodiment of the present invention;

FIG. 2 is a perspective view of the apparatus of FIG. 1, shown in an installed position;

FIG. 3 is a rear view of a part of the apparatus of FIG. 1, shown in a flat condition;

FIG. 4 is a sectional view taken on line 4-4 of FIG. 3;

FIG. 5 is a sectional view taken on line 5-5 of FIG. 3;

FIG. 6 is a top view of parts shown in FIG. 2;

FIG. 7 is an enlarged partial sectional view of parts shown in FIG. 6;

FIG. 8 is a partial sectional view of a part of another apparatus comprising an embodiment of the invention, shown in an installed position;

FIG. 9 is a sectional view of the part of FIG. 8, shown in a flat condition;

FIG. 10 is a sectional view of parts of yet another apparatus comprising an embodiment of the invention, shown in installed positions;

FIG. 11 is a sectional view of the part of the apparatus shown in FIG. 8, with a trim strip shown in an installed position;

FIG. 12 is an end view of the trim strip of FIG. 11;

FIG. 13 is a view similar to FIG. 11, further showing a base strip;

FIG. 14 is an end view of the base strip of FIG. 13;

FIG. 15 is a view similar to FIG. 11, showing an alternative trim strip; and

FIG. 16 is an end view of the trim strip of FIG. 15.

### DESCRIPTION OF THE PREFERRED EMBODIMENT

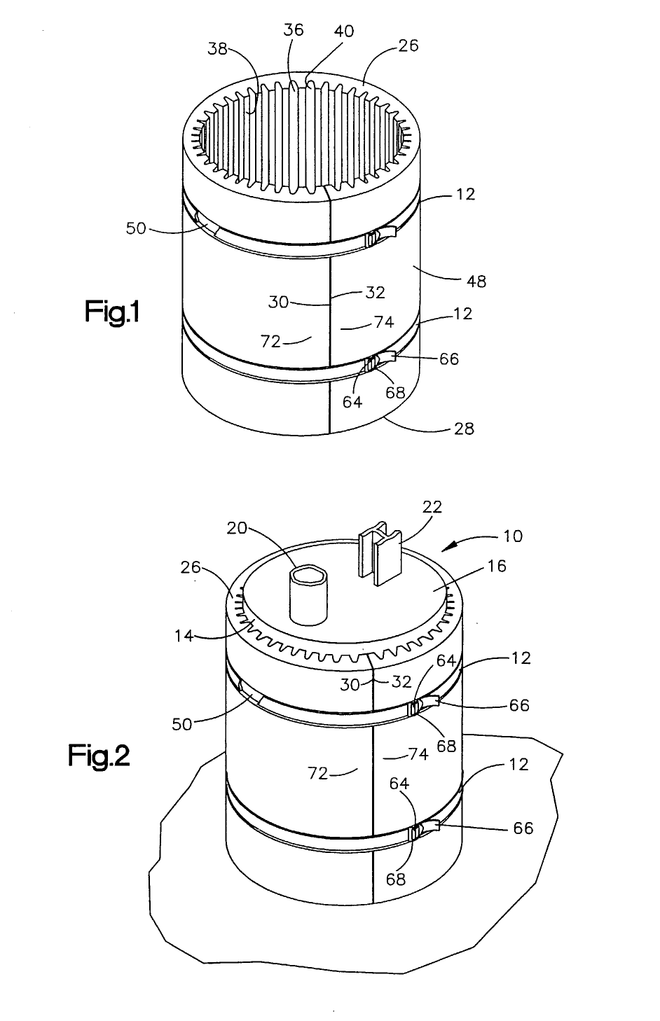

Referring now to the drawings wherein the showings are for purposes of illustrating a preferred embodiment of the invention only and not for purposes of limiting the same, FIGS. 1-16 show the present invention. With reference to FIG. 1, the apparatus includes a compressible pad 10 and two straps 12. As shown in FIG. 2, the pad 10 has an installed position wrapped about a cylindrical outer surface 14 of a column 16. In this particular embodiment, the column 16 is a concrete structure which encases structural members including a pipe 20 and a steel column 22. The straps 12 are used to fasten the pad 10 in the installed position. The pad 10 serves as a cushion to protect the column 16 against an impact from a moving vehicle (not shown).

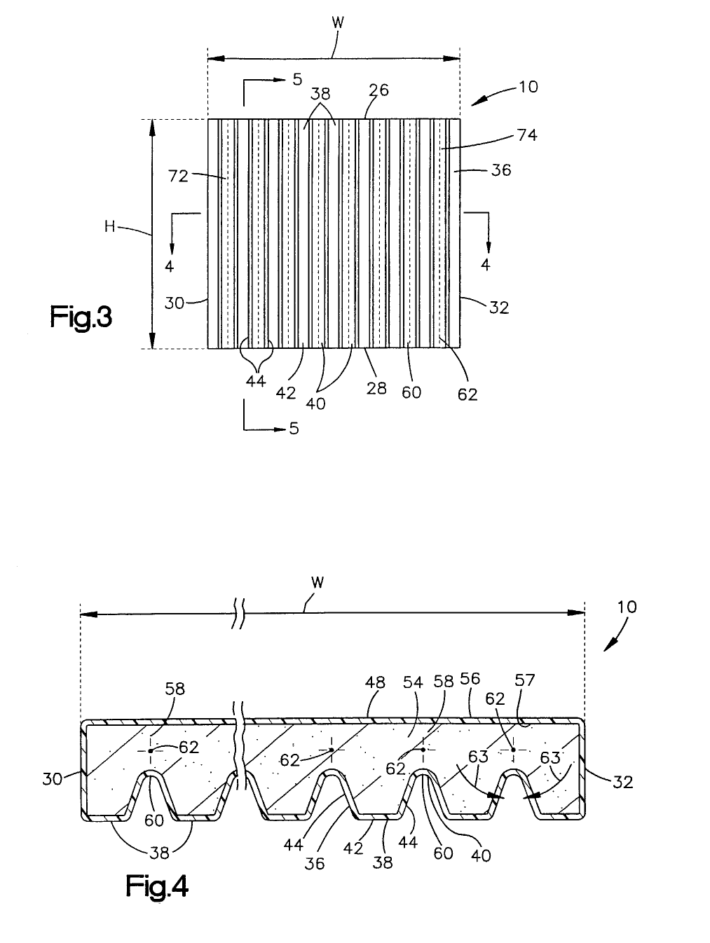

With reference to FIGS. 3-5, the pad 10 initially has a flat condition for handling and storage. The pad has a height H defined by and between upper and lower end edges 26 and 28. The pad 10 also has an original width W defined by and between opposite side edges 30 and 32. An inner side surface 36 of the pad 10 has a corrugated contour defined by vertically-extending ribs 38 separated by grooves 40. Each rib 38 has a crown 42 extending between two sidewalls 44. The crowns 42 are coplanar when the pad 10 is in the flat condition. This promotes abutting contact of each crown 42 with the cylindrical outer surface 14 of the column 16, as shown in FIG. 2, along the length of the crown 42 when the pad 10 is in the installed position about the column 16.

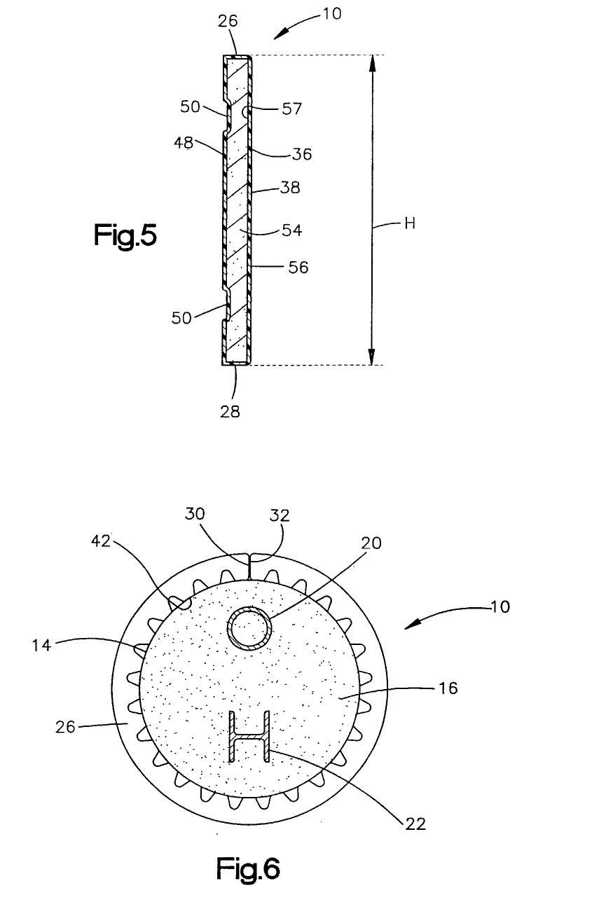

With continuing reference to FIG. 5, an outer side surface 48 of the pad 10 is planar when the pad 10 is in the flat condition. The pad 10 has two horizontally-extending recesses 50 that extend fully across the outer side surface 48 between the opposite side edges 30 and 32. Each recess 50 is configured to receive a corresponding strap 12, as shown in FIG. 2, for fastening the pad 10 in the installed position about the column 16.

In this particular example of the invention, the pad 10 is compressible. Specifically, this particular pad 10 is formed of a compressible core 54 and a noncompressible shell 56 that envelopes the core 54. The core 54 is formed of a closed cell foam. The material of the shell 56 is stiffer than the material of the core 54. In this particular embodiment, the shell 56 is bonded to the core 54 along the entire inner surface 57 of the shell 56 and completely envelopes the core 54. The shell 56 thus defines the upper and lower end edges 26 and 28, the inner and outer side surfaces 36 and 48, and the side edges 30 and 32, as shown in FIG. 4, of the pad 10. The core 54 and the shell 56 are both formed of plastic material. In this embodiment, the pad 10 is manufactured by a rotational molding process in which the core 54 and the shell 56 are formed from MSTR-007 and MSTR-009EVA, respectively. These two materials are sold together under the trade name “One-Step Foam Polyetheylene Resin System” by Equistar Chemicals, LP, of Houston, Tex.

With reference to FIG. 4, the pad 10 has a plurality of thinned sections 58, each of which extends between a bottom surface 60 of a respective groove 40 and the outer side surface 48. Each thinned section 58 serves as hinge to enable the pad 10 to bend inwardly along a corresponding fold line 62, as indicated by the arrows 63. This enables the pad 10 to be bent inwardly from the flat condition to an arcuate condition, as in FIG. 6, when the pad is installed about the column 16. It is preferred that the pad 10 bend inwardly towards the ribs 38 to enable easy installation. More specifically, due to the difference between the inner and outer circumferences, absence of the corrugated ribs 38 prevents optimal bending due to the stiffness of the pad 10. If bending does occur, it is through buckling. The corrugated ribs 38 provide a release point so that buckling is eliminated and the pad 10 fits properly around the column 16. Bending the pad 10 in the reverse direction, i.e. inwardly towards the planar surface 48, is not desired because the pad 10 is resistant to such bending due to the tension and the strength of the entire length of the product. This is attributed to the plastic material utilized to fabricate the pad 10.

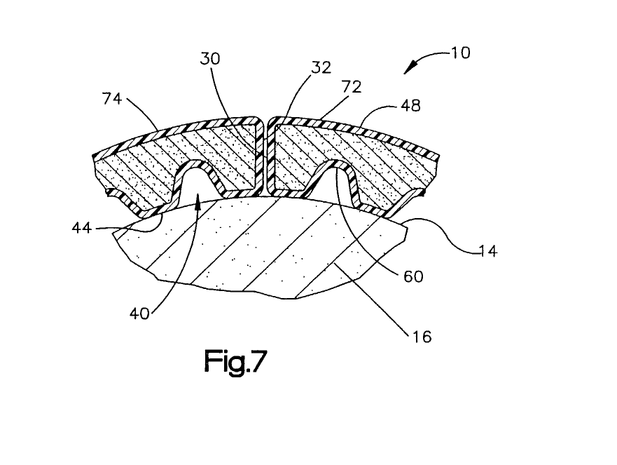

With reference to FIGS. 2, 3, 6 and 7, installation of the pad 10 will now be described. To install the pad 10 about the column 156, the pad 10 is bent inwardly and wrapped about the column 16. In this embodiment, the original width W, shown in FIG. 3, of the pad 10 approximately equals the circumference of the cylindrical outer surface 14 of the column 16. Therefore, as the pad 10 is wrapped about the column 16, the side edges 30 and 32 approach each other and ultimately come into abutting relationship or close proximity with each other, as shown in FIGS. 6 and 7. As shown in FIG. 2, the straps 12 are then used to fasten the pad 10 in the installed position. The ends 64 and 66 of each strap 12 are fastened together with a buckle 68. The pad 10 is thus placed in the installed position about the column 16, with the upper and lower end edges 26 and 28 extending horizontally about the column 16 and the side edges 30 and 32 extending vertically along the column 16.

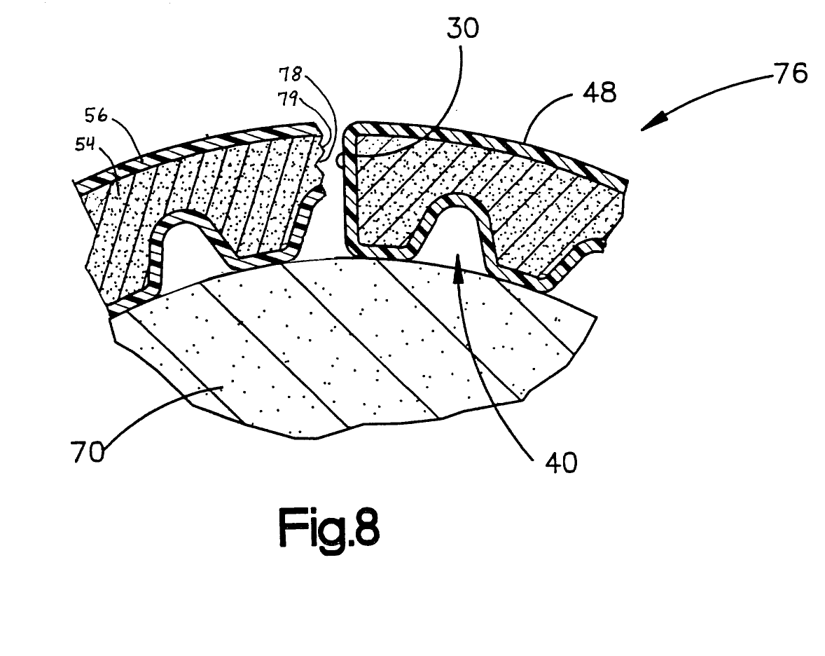

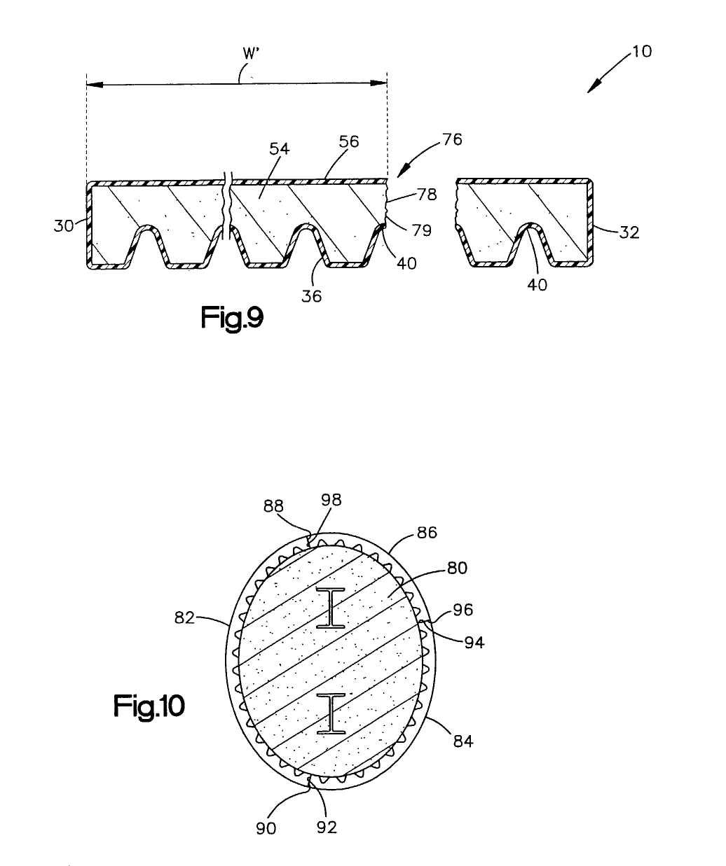

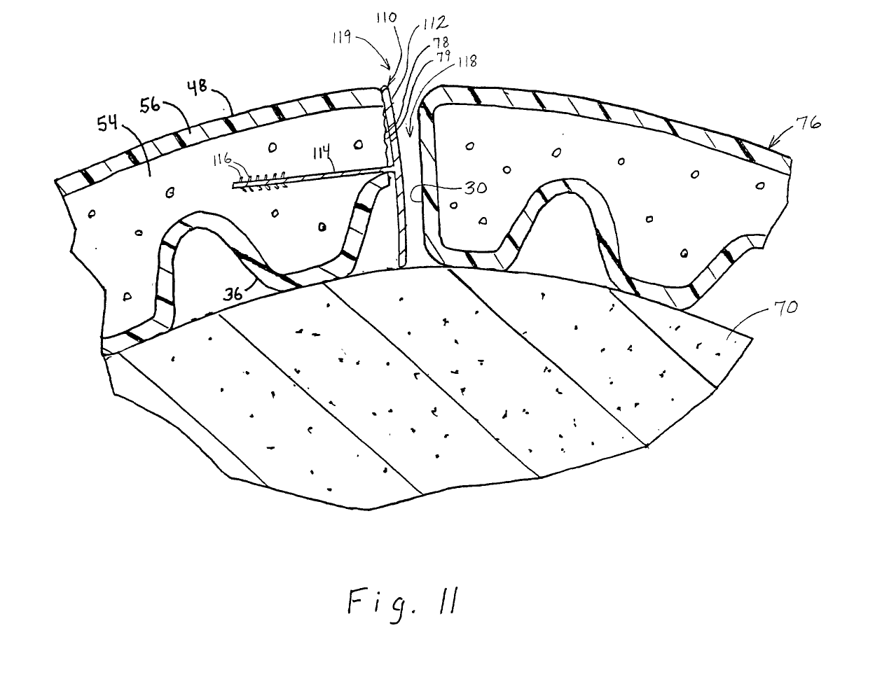

With reference to FIGS. 8 and 9, another embodiment of the present invention is shown. As shown in FIG. 8, a smaller column 70 has a circumference that is less than the original width W, illustrated in FIG. 3 of the pad 10. If the pad 10 were wrapped about the smaller column 70, opposite end portions 72 and 74 from overlapping, the width W of the pad 10 must be reduced to correspond to the circumference of the smaller column 70. This is accomplished by severing the pad 10. More specifically, referring to FIG. 9, the pad 10 is severed along one of the grooves 40, which serves as a cutting guide. This yields a severed pad 76 having a reduced width W′ that approximately equals the circumference of the column 70. The severed pad 76 has the original, shell-covered side edge 30 and a new, severed side edge 78. At the severed side edge 78, the core 54 has an exposed surface 79 that is not covered by the shell 56. Then, as shown in FIG. 8, the severed pad 76 is wrapped about the smaller column 70. The reduced width W′, as shown in FIG. 9, enables the shell-covered side edge 30 to come into abutting relationship or close proximity with the severed side edge 74.

The straps 12 of FIG. 2 are wrapped about the severed pad 76 and seated in the corresponding recesses 50. The ends 64 and 66 of each strap 12 are fastened together with the respective buckle 68. The same straps 12 used in the embodiment of FIG. 7 can be used in the embodiment of FIG. 8 because the buckles 68 enable the straps 12 to accommodate a range of column diameters and pad widths.

The straps 12 can thus be used to fasten in the installed position, either the original pad 10, shown in FIG. 4, having the original width W or any severed pad 72, shown in FIG. 9, having any reduced width W′ achieved through severing of the original pad 10. Referring to the embodiments of FIGS. 7 and 8, both the shell-covered side edges 30 and 32 and the severed side edge 74 are free of any fastening structure. In both embodiments, the fastening function is achieved solely through the straps 12, as seen in FIG. 2.

With reference to FIG. 10, another embodiment is shown. In this embodiment, a larger column 80 has a circumference that is greater than the original width W, as seen in FIG. 3, of the pad 10 of the first embodiment. The pad 10 of the first embodiment is not wide enough to span the entire circumference of the larger column 80. Therefore, a plurality of pads are wrapped about the column 80. However, beforehand, one or more of the pads can be severed to adopt a reduced width such that the pads together span the entire circumference of the column 80 without overlapping each other.

More specifically, this embodiment includes first, second and third pads 82, 84 and 86. Each pad 82, 84 and 86 initially has the same unsevered structure, with the same original width W, as shown in FIG. 3, as that of the pad 10 of the first embodiment. Each of the second and third pads 84 and 86 are severed to attain a reduced width such that the first, second and third pads 82, 84 and 86 will span the circumference of the column 80 without overlapping each other. Then, the first, second and third pads 82, 84 and 86 are wrapped about the larger column 80. The first pad 82, being unsevered, has two shell-covered side edges 88 and 90, similar to the shell-covered side edges 30 and 32 of FIG. 4 described above. The second pad 84 has a shell-covered side edge 92 and also a severed side edge 94, similar to the severed side edge 74 of FIG. 8 described above. The third pad 86 has two severed side edges 96 and 98.

Each pad 82, 84 and 86 extends only partly around the circumference of the column 80. The three pads 82, 84 and 86 together span the circumference of the column 80 without overlapping each other. Each side edge 88, 90, 92, 94, 96 and 98 is in abutting relationship or close proximity to a side edge 88, 90, 92, 94, 96 and 98 of an adjacent pad 82, 84 and 86.

As described above, the straps 12 shown in FIG. 2 are wrapped about the pads 82, 84, and 86 and seated in the corresponding recesses 50. The ends 64 and 66 of each strap 12 are fastened together with the respective buckle 68. The same strap 12 used in the embodiment of FIG. 6 can be used in this embodiment of FIG. 1, even though the embodiments differ in column circumference, pad width, side edge configuration, and number of pads.

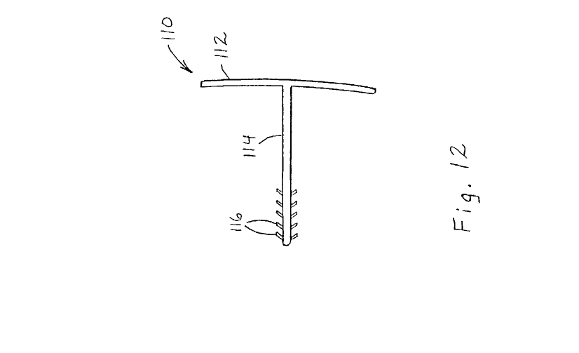

With reference to FIG. 8, the severed side edge 78 of the severed pad 76 as an exposed surface 79. The exposed surface 79 can be covered by a trim strip. One example is an extruded plastic trim strip 110 shown in an installed position in FIG. 11. This trim strip 110 has a T-shaped profile, shown in FIG. 12, width an arcuate crown 112, a stem 114 perpendicular to the crown 112, and rigid barbs 116 along the stem 114. The trim strip 110 has a length that is preferably equal to the height H, shown in FIG. 3, of the pad 10, so that the trim strip 110 can extend vertically fully between the upper and lower end edges 26 ad 28, shown in FIG. 3, of the pad 76. As shown in FIG. 11, the stem 114 is pressed through the exposed surface 79 into the core 54 until the crown 112 abuts or nearly abuts the pad 76 so as to cover the severed side edge 78. The barbs 116 help to retain the trim strip 110 in the core 54 by resisting movement of the stem 114 back outward from the core 54. The crown 112 is located in the gap 118 between the side edges 30 and 78.

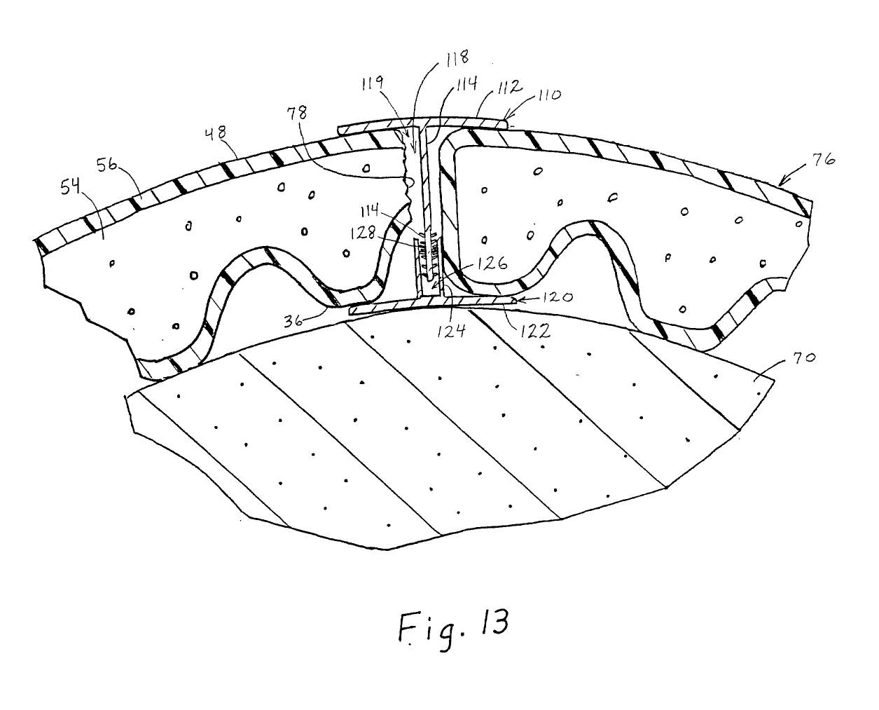

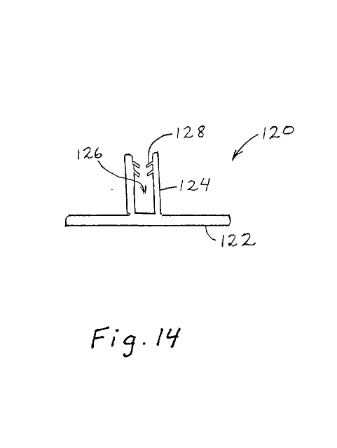

Alternatively, the trim strip 110 can be installed in a different position, as shown in FIG. 13. Instead of being inserted in the core 54, the stem 114 is inserted in the gap 118. In this position, the crown 112 overlies the outer side surface 48 adjacent the side edges 30 and 78. The crown thus covers the gap 118 to conceal the seam 119 defined by the side edges 30 and 78. With reference to FIG. 1, the strap 12 described with reference to the first embodiment extends across the crown 112 of the trim strip 110 when the strap 12 is installed about the pad 76.

The trim strip 110 is held in place by an extruded base strip 120 having a length that is preferably equal to that of the trim strip 110. The base strip 120 has a T-shaped profile shown in FIG. 14, with a straight crown 122 and a stem 124. The stem 124 has a groove 126 with internally extending rigid barbs 128. As shown in FIG. 13, the stem 114 of the trim strip 110 is pressed into the groove 126 of the base strip 120 to clamp the two crowns 112 and 122 about the inner and outer side surfaces 36 and 48 adjacent the side edges 30 and 78. The barbs 128 of the base strip 120 lock on the barbs 114 of the trim strip 110 to retain the trim strip 110 in place. The two strips 110 and 120 interlock and grip the end portions of the pad 76 adjacent the end edges 30 and 78. In this configuration, the crown 112 covers the gap 118 to conceal the seam 119. Additionally, in this configuration, the two strips 110 and 120 cooperate to help to couple the end portions of the pad 76 adjacent the end edges 30 and 78 together and to retain them against the column 70.

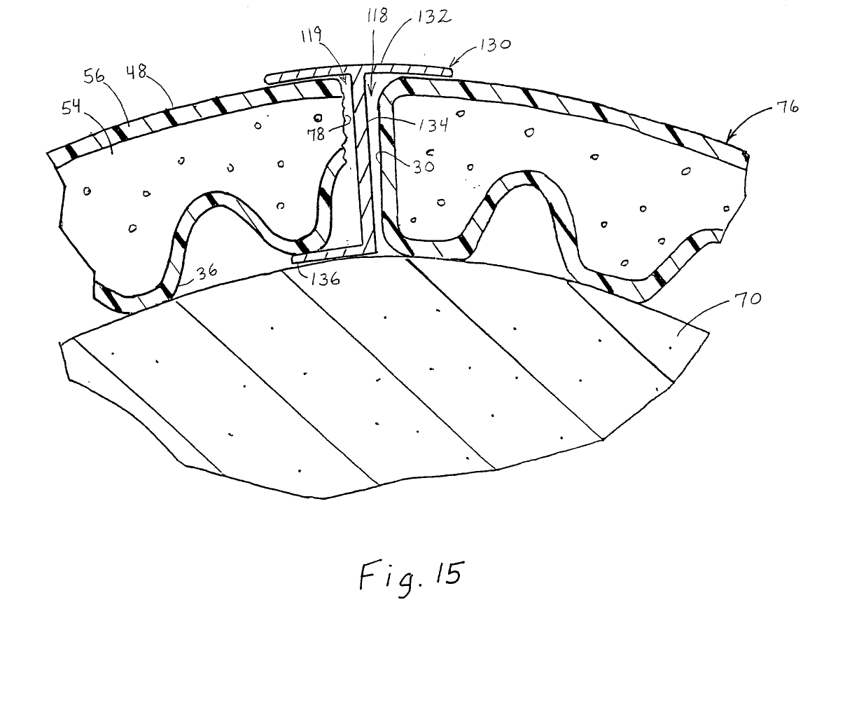

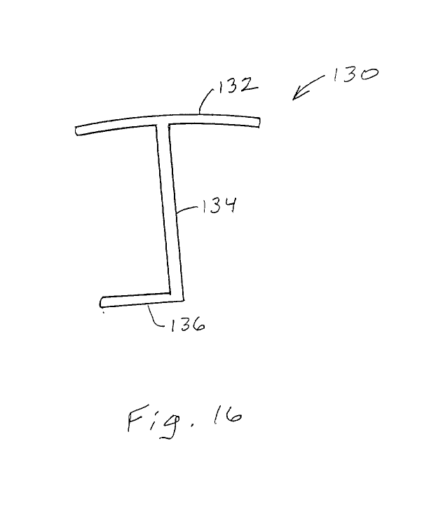

Another example of a trim strip is a trim strip 130 shown in FIG. 15. This trim strip 130 has a length that is preferably equal to the height H, as shown in FIG. 3, of the pad 10, so that the trim strip 130 can extend vertically fully between the upper and lower end edges 26 and 28, as shown in FIG. 3, of the pad 76. The trim strip 130 has a profile shown in FIG. 16, with an arcuate crown 132, a stem 134 perpendicular to the crown 112, and a base wall 136 perpendicular to the stem 134. In the installed position shown in FIG. 15, the stem 132 is within the gap 118 between the side edges 30 and 78. The crown 112 overlies the outer side surface 48 adjacent the side edges 30 and 789. The base wall 136 is located between the side edge 78 and the column 70. As described above, the strap 12 shown in FIG. 1 extends across the crown 112 of the trim strip 110 when the strap 12 is installed about the pad 76.

The crown 132 and the base wall 136 preferably fit tightly about the inner and outer surfaces 36 and 48 adjacent the side edge 78 in an interference fit. The strip 130 thus grips the end portions of the pad 76 adjacent the end edges 30 and 78. In this configuration, the crown 132 covers the gap 118 to conceal the seam 119. Additionally, in this configuration, the strip 130 helps to couple the end portions of the pad 76 adjacent the side edges 30 and 78 together and to retain them against to the column 70.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. An apparatus for protecting a structural column from an impact, said apparatus comprising:
a flexible pad configured to have an installed position wrapped about the column;
said pad having an original width defined by and between opposite side edges, and having a height defined by and between upper and lower end edges that extend horizontally about the column when said pad is in said installed position;
said pad having a non-corrugated outer side surface, and a corrugated inner side surface having ribs configured to extend vertically in contact with the column when said pad is in said installed position;
said ribs being separated by grooves configured as cutting guides along which said pad can be severed to adopt a reduced width corresponding to a particular column.

2. The apparatus of claim 1, further comprising a strap configured to fasten said pad in said installed position either in said original width or in any reduced width achieved through said severing.

3. The apparatus of claim 2, wherein said pad has a horizontally-extending recess at said outer side surface for receiving said strap when said pad is in said installed position.

4. The apparatus of claim 1, wherein said side edges are free of a fastening structure.

5. The apparatus of claim 1, wherein said pad is flexible to enable bending of said pad from a flat condition to a bent condition for wrapping about the column, and wherein said outer side surface is planar when said pad is in said flat condition.

6. The apparatus of claim 1, wherein said pad is configured to extend only partly around the periphery of the column when said pad is in said installed position.

7. The apparatus of claim 1, wherein said pad has a compressible core and a noncompressible shell that envelopes said core.

8. The apparatus of claim 7, wherein said shell completely envelopes said core, such that said shell defines said upper and lower end edges, said inner and outer side surfaces, and said side edges when said pad has said original width.

9. The apparatus of claim 8, wherein said shell is bonded to said core.

10. The apparatus of claim 1, further comprising a plurality of pads adapted to wrap about the column, wherein one or more of said pads can be severed to adopt a width suitable for said pads to span the entire circumference of the column.

11. The apparatus of claim 10, wherein each of said pads wrap about the column without overlapping.

12. An apparatus for protecting a column from an impact, said apparatus comprising;
a flexible pad configured to have an installed position wrapped about the column;
said pad having an original width defined by and between opposite side edges, and having a height defined by and between upper and lower end edges; and,
said pad having a non-corrugated outer side surface, and corrugated inner side surface having ribs configured to extend vertically in contact with the column when said pad is in said installed position.

13. The apparatus of claim 12, wherein said pad further comprises a compressible core and a noncompressible shell that envelopes said core.

14. The apparatus of claim 12, further comprising a strap configured to fasten said pad in said installed position either in said original width or in an reduced width achieved through severing said pad.

15. The apparatus of claim 12, wherein said pad has a horizontally-extending recess at said outer side surface for receiving said strap when said pad is in said installed position.

16. The apparatus of claim 12, wherein said pad is flexible to enable bending of said pad from a flat condition to a bent condition for wrapping about the column, and wherein said outer side surface is planar when said pad is in said flat condition.

17. The apparatus of claim 12, wherein said pad is configured to extend only partly around the periphery of the column when said pad is in said installed position.

18. The apparatus of claim 12, wherein said shell completely envelopes said core, such that said shell defines said upper and lower end edges, said inner and outer side surfaces, and said side edges when said pad has said original width.

19. The apparatus of claim 12, further comprising a plurality of pads adapted to wrap about the column, wherein one or more of said pads can be severed to adopt a width suitable for said pads to span the entire circumference of the column, wherein each of said pads wrap about the column without overlapping.

20. A method for installing an apparatus for protecting a column, comprising the steps of:
providing a flexible pad configured to have an installed position wrapped about the column; said pad having an original width defined by and between opposite side edges, and having a height defined by and between upper and lower end edges that extend horizontally about the column when said pad is in said installed position; and, said pad having a non-corrugated outer side surface, and corrugated inner side surface having ribs configured to extend vertically in contact with the column when said pad is in said installed position;
bending said pad inwardly toward said corrugated inner side;
wrapping said pad around the column; and,
securing said pad to said column.

21. The method of claim 20, wherein said corrugated inner surface comprises a groove, said groove being a cutting guide.

22. The method of claim 21, further comprising the step of:
severing said pad along said groove;
reducing the width of said pad; and,
wrapping said pad around the column, wherein the column circumference is less than the original pad width.

23. The method of claim 20, further comprising the step of:
providing a plurality of pads, wherein each of said pads is configured to have an installed position wrapped about the column; said pads having an original width defined by and between opposite side edges, and having a height defined by and between upper and lower end edges that extend horizontally about the column when said pads are in said installed position; and, each of said pads having a non-corrugated outer side surface, and corrugated inner side surface having ribs configured to extend vertically in contact with the column when said pad is in said installed position, the column having a circumference larger than the original width of each pad; and,
wrapping said plurality of pads about the circumference of said column.

24. The method of claim 23, further comprising the steps of:
severing at least one of said pads along a groove so that the pad width is smaller than the original width; and,
securing said pads to the column without said pads overlapping.
